(19) United States
(12) Patent Application Publication
(10) Pub. No.: US 2024/0066541 A1
(43) Pub. Date: Feb. 29, 2024

(54) PUSH ACTUATED DOUBLE FLUID DISPENSER

(71) Applicant: SENSILE MEDICAL AG, OLTEN (CH)

(72) Inventors: ALEXANDRE PERRIER, LIESTAL (CH); CHRISTIAN HUBER, BERN (CH); MATTHIAS MÜLLER, HÄGENDORF (CH)

(21) Appl. No.: 18/451,881

(22) Filed: Aug. 18, 2023

(30) Foreign Application Priority Data
Aug. 29, 2022 (EP) 22192530.8

(51) Int. Cl. B05B 11/10

(52) U.S. Cl. CPC B05B 11/1084; B05B 11/1028; B05B 11/1053

(57) ABSTRACT

Push actuated double fluid dispenser (1), comprising a container (2) having a first cavity (4a) and a second cavity (4b) separated from the cap first cavity (4a), and a dispensing pump device (6) in a general form of a cap assembled to the container over the first and second cavities, the dispensing pump device comprising a base part (7) and a cap part (8) including a pump mechanism (16) comprising an elastic flexible pump membrane (18) manually movable from an uncompressed state to a compressed state. The pump mechanism (16) further comprises a separating wall (20) extending from an underside of the pump membrane (18) and inserted into a slot in the base part, the separating wall separating a first pump chamber (22a) from a second pump chamber (22b), both first and second pump chambers provided in a volume below the pump membrane (18), the first pump chamber connected fluidically to a first inlet channel (10a) and a first outlet channel (11a), the second pump chamber connected fluidically to a second inlet channel (10b) and second outlet channel (11b), the inlet channels fluidically interconnecting the respective first and second cavities to the respective first and second pump chambers, valves (13) being positioned between the inlet channels and the pump chambers configured to allow fluid flow only in the direction from the cavities to the respective pump chambers, and the outlet channels interconnecting the pump chambers to an outlet nozzle (12) of the dispenser, outlet valves (24a, 24b) being positioned in the outlet channels configured to allow fluid flow only in the direction from the pump chambers to the outlet nozzle.

### TECHNICAL FIELD

This invention relates to a fluid dispenser for dispensing two fluids simultaneously, each of the two fluids being contained in a separate container portion. The fluid dispenser is push actuated, for instance by manually pressing a pump actuation portion. The fluids may typically include liquids and gels of various substances that are desirable to keep separated prior to use and that should be combined together in a pre-determined proportion upon use. Such double fluid dispensers may for instance be used in the cosmetic or pharmaceutical industry for topical application of creams, gels, and other substances possibly containing active pharmaceutical compounds, essential oils, excipients, phytosanitary compounds, and other such substances.

### DESCRIPTION OF RELATED ART

There are many applications in which the fluid dispenser should be a low-cost disposable device that may be disposed of after the fluid in the containers have been consumed. There may be various reasons for keeping the two fluids separate prior to use, for instance to increase shelf life by avoiding interaction between fluids prior to being dispensed, or for ensuring a proper mix or dosage of substances that are not soluble together. There are many applications in which the fluid dispenser should be manually actionable.

Low-cost push actuated double fluid dispensers are generally known. In conventional designs, there are typically two pump mechanisms that draw the fluid from each container and join the two fluids, for instance via a Y-shaped canal to a common outlet in which both fluids are dispensed simultaneously. Many conventional systems require quite a lot of parts thus increasing the manufacturing and assembly costs and also rendering the dispenser bulky. Moreover, many conventional dispensers may include metal components for the springs and valves, for instance in plastic housings, which is not ideal for recycling of the disposable components after use.

### SUMMARY OF THE INVENTION

In view of the foregoing, it is an object of the invention to provide a push actuated double fluid dispenser that is economical to produce, yet enables the dispensing of two fluids in a pre-determined volume ratio in a reliable and accurate manner.

It is advantageous to provide a push actuated double fluid dispenser that is compact.

It is advantageous to provide a push actuated double fluid dispenser that minimizes the environmental impact from production to disposal thereof.

Objects of the invention have been achieved by providing the manually actuated fluid dispenser according to claim 1. Dependent claims set forth various advantageous embodiments of the invention.

Disclosed herein is a push actuated double fluid dispenser, comprising a container having a first cavity and a second cavity separated from the cap first cavity, and a dispensing pump device in a general form of a cap assembled to the container over the first and second cavities, the dispensing pump device comprising a base part and a cap part including a pump mechanism comprising an elastic flexible pump membrane movable by a finger or pressing device from an uncompressed state to a compressed state. The pump mechanism further comprises a separating wall extending from an underside of the pump membrane and inserted into a slot in the base part, the separating wall separating a first pump chamber from a second pump chamber, both first and second pump chambers provided in a volume below the pump membrane. The first pump chamber is connected fluidically to a first inlet channel and a first outlet channel, and the second pump chamber is connected fluidically to a second inlet channel and second outlet channel. The inlet channels fluidically interconnect the respective first and second cavities to the respective first and second pump chambers. Valves are positioned between the inlet channels and the pump chambers configured to allow fluid flow only in the direction from the cavities to the respective pump chambers. The outlet channels interconnect the pump chambers to an outlet nozzle of the dispenser, outlet valves being positioned in the outlet channels configured to allow fluid flow only in the direction from the pump chambers to the outlet nozzle.

In an advantageous embodiment, the cap part comprises a rigid top wall and the pump membrane protrudes above the rigid top wall.

In an advantageous embodiment, the pump membrane and at least a top wall of the cap part are integrally formed as an injection-molded multi-material part, the cap housing top wall being formed of a rigid thermoplastic polymer and the sealing membrane of a thermoplastic elastic polymer.

In an advantageous embodiment, the separating wall comprises a supple portion integrally formed with the pump membrane of the same material as the pump membrane, and a rigid portion formed of a different polymer more rigid than the polymer of the sealing membrane.

In an advantageous embodiment, the rigid portion is integrally formed with a top wall of the cap part in the same material as the top wall of the cap part.

In an advantageous embodiment, the inlet valve is made of the same material as the pump membrane.

In an advantageous embodiment, the outlet valves are made of the same material as the pump membrane.

In an advantageous embodiment, the inlet valve is made of an injection-molded component that is formed integrally with the cap part as a multi-material injection-molded part.

In an advantageous embodiment, the outlet valve is made of an injection-molded component that is formed integrally with the cap part as a multi-material injection-molded part.

In an advantageous embodiment, the inlet valve comprises a flexible sealing lip integrally formed with an anchor portion fixed to a top wall of the cap part, the flexible sealing lip pressing against a valve seat provided at an upper end of the inlet channels formed on the base part.

In an advantageous embodiment, the separating wall comprises a supple portion that is configured to collapse elastically when the pump membrane is pressed from an unactuated position to an actuated position in which the pump chambers are emptied.

In an advantageous embodiment, the outlet valves comprise a flexible membrane that press against an outlet end of the outlet channels and that are configured to be elastically biased when liquid is expulsed from the pump chambers.

In an advantageous embodiment, the cap part comprises holes or spaces opposite the outlet orifices configured to allow elastic displacement of the valve flexible membrane away from the outlet orifices.

In an advantageous embodiment, an outer surface of the base part comprises an after-valve channel formed as an indent or a protuberance surrounding the outlet orifices to guide expulsed fluids downstream of the outlet valves to an outlet nozzle of the fluid dispenser.

### BRIEF DESCRIPTION OF THE DRAWINGS

Further objects and advantageous features of the invention will be apparent from the claims, from the detailed description, and annexed drawings, in which:

FIG. 1 is a perspective exploded view of a fluid dispenser according to an embodiment of the invention;

FIG. 2 is an exploded perspective view of a dispensing pump device portion of the fluid dispenser of FIG. 1;

FIG. 3 is a perspective cross-sectional view of a fluid dispenser according to an embodiment of the invention;

FIGS. 4a and 4b are cross-sectional views through the fluid dispenser according to embodiments of the invention, the cross-sectional views being through vertical planes;

FIG. 4c is a cross-sectional view through line 4c-4c of FIG. 4a;

FIG. 5 is a perspective cross-sectional view of the fluid dispenser according to an embodiment of the invention with a cap part of a dispensing pump device portion removed;

FIG. 6 is a perspective view from a bottom side of a cap part of a dispensing pump device of the fluid dispenser according to an embodiment of the invention;

FIG. 7 is a cross-sectional similar to FIG. 5 of the fluid dispenser fully assembled;

FIG. 8 is a perspective detailed cross-sectional view of a dispensing pump device of the fluid dispenser, in particular showing outlet of the dispenser.

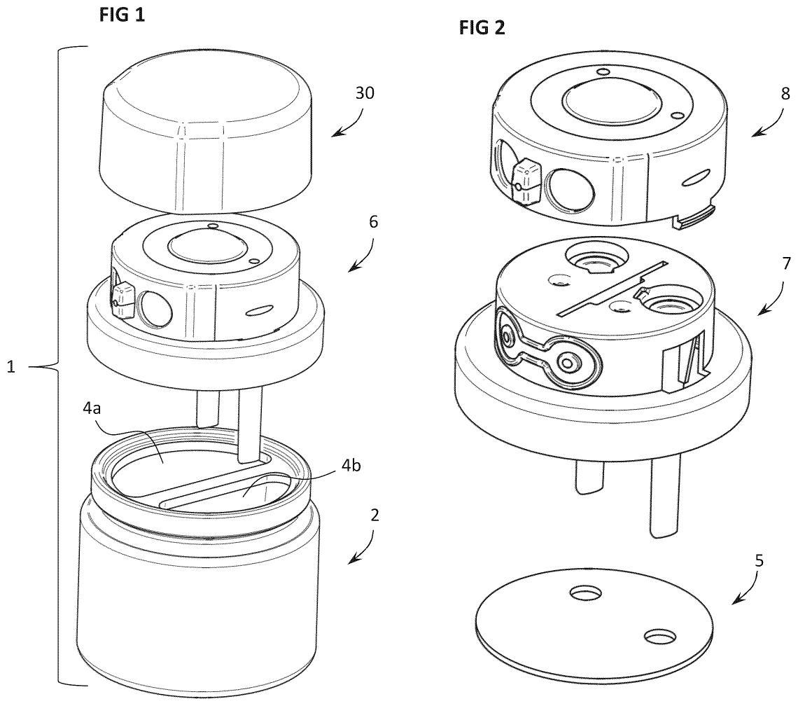

### DETAILED DESCRIPTION OF EXEMPLARY EMBODIMENTS

Referring to the figures, a push actionable double fluid dispenser 1 is illustrated comprising a container 2 and a dispensing pump device 6 assembled to the container 2. The container 2 comprises a first cavity 4a for containing a first fluid and a second cavity 4b for containing a second fluid whereby the first and second cavities may have identical volumes, or one of the cavities may have a smaller volume than the other cavity depending on the ratio of dispensing of the first fluid with respect to the second fluid. For instance, in certain applications the ratio of first fluid to second fluid may be one to one, or one to two, or one to three, or various other ratios specifically configured for the types of fluids to be dispensed.

As mentioned in the background section, fluids may comprise various compositions and viscosities for different uses, typically topical uses in the cosmetic or drug industry.

The container 2 comprises an open side having a rim 3 forming for instance a flange defining a bottom shoulder 30 for securing the dispensing pump device 6 having a complementary locking shoulder on a peripheral housing part 31 thereof. The dispenser 1 further comprises a gasket 5 that is sandwiched between the dispensing pump device 6 and an upper portion of the rim 3, for instance fitting within a gasket 5 receiving indent 32 to sealingly close the first and second cavities 4a, 4b except for fluidic connections interconnecting the cavities to the dispensing pump device 6 via feed tubes 9a, 9b that extend through orifices provided in the gasket 5.

The dispensing pump device 6 comprises a base part 7 and a cap part 8 separately formed from the base part 7 and assembled thereto.

The base part 7 comprises a first feed tube 9a having an inlet channel 10a and a second tube 9b having an inlet channel 10b. The first and second feed tubes extend into respective first and second cavities 4a, 4b, to an end 33 proximate a bottom surface 34 of the cavities in order to pump liquid out of the cavities until it is almost empty when positioned vertically as illustrated. In other words, the dispenser 1 is intended to be placed on a substantially horizontal surface and actuated by a user pushing with a finger on the top of the fluid dispenser 1 whereas the dispensed fluid is ejected via an outlet nozzle 12 transversely, for instance generally horizontally as is per se well-known in many dispensing devices. Actuation may also be performed by a mechanical or electrical device that has a movable piston or other type of pushing mechanism that presses on the top of the fluid dispenser to perform a pumping action.

The base part 7 further comprises a first outlet channel 11a and a second outlet channel 11b.

The cap part 8 comprises first and second inlet valves 13a, 13b, a pump mechanism 16 and first and second outlet valves 24a, 24b.

The pump mechanism 16 comprises an elastic pump membrane 18 and a separating wall 20 extending from an underside of the pump membrane and separating a volume under the pump membrane into a first pump chamber 22a and a second pump chamber 22b. The separating wall extends into a slot 35 provided in the base part 7, the slot sealingly engaging the separating wall so as to sealingly separate the first pump chamber 22a from the second pump chamber 22b across the separating wall. The separating wall comprises a rigid portion 20b that inserts into the receiving slot 35 in the base part, and a supple portion 20a that allows the pump membrane 18 to be deformed towards the base part and when released to spring back to its natural position ready for a subsequent pump cycle.

The pump membrane 18 may be formed of an elastic polymer material compatible with the fluids to be dispensed and having sufficient elastic modulus to ensure that the membrane may be pressed against the base part upon actuation and has a sufficient spring force to pop back to its natural position and draw fluids from the respective fluid cavities 4a, 4b as it elastically biases back to the natural unbiased position. Examples of elastic polymers suitable for the pump membrane includes thermoplastic elastomers and silicone rubbers.

As illustrated in the figures, the membrane may have a general spherical dome shape protruding above a rigid top wall of the cap part, however various other non-spherical shapes protruding above the surrounding rigid upper surface may be provided, such as tapered conical, cylindrical, or irregular shapes provided that they protrude above the rigid portion of the cap surface surrounding the membrane and provide pump chamber volumes below the membrane that have a variable volume as the user presses down on the membrane, typically with a finger.

The supple portion 20a of the separating wall may be advantageously integrally formed with the pump membrane 18 and be made of the same material. The rigid portion 20b of the separating wall may be integrally formed with the top wall 26 of the cap part 8 and formed of the same polymer material as the cap part rigid top wall. The rigid portion of the cap part may for instance be made of various thermoplastic polymers, compatible with the liquids to be dispensed, such as polypropylene, polyethylene, Methyl methacrylate-acrylonitrile-butadiene-styrene (MABS).

In particular, the materials of the sealing membrane and of the cap top wall and other rigid parts of the cap may advantageously be made of polymeric materials that may be injection-moulded together in a multi-component moulding process. Two component injection-moulding processes are per se known for various applications, however such a process in the scope of the present invention brings significant advantages in reducing the number of components, simplifying assembly and reducing the bulkiness of the dispensing pump device.

The first and second pump chambers 22a, 22b are each arranged above respective first and second inlet channels 10a, 10b via respective inlet valves 13a, 13b such that when the pump membranes move from a collapsed position pressed against the top surface of the base part, the liquids are drawn from the respective first and second cavities 4a, 4b in a proportion corresponding to the volumes of the first and second pump chambers 22a, 22b. The inlet valves may advantageously be in the form of flexible flaps, for instance similar to an umbrella or Belleville valve, made of an elastic polymer, and preferably of the same material as the pump membrane 18. The elastomeric material of the inlet valves 13a, 13b may thus be similarly formed with the rigid polymer portions of the cap part 8 in a two-component injection moulding process as described above. In variants, the inlet valves may however be made of a material different to the material of the pump membrane.

In the illustrated embodiment, the inlet valves comprise a central anchor portion or stem 14 and a flexible umbrella or disk-shaped sealing lip 15 extending therefrom which in the closed position presses against a valve seat 27 on a top end of the feed tubes to which the inlet channels are formed. When liquid is being drawn into the pump chambers, the sealing lips 15 of the valves lift off the valve seat 27 to allow liquid to flow from the respective cavities 4a, 4b of the container into the respective pump cavities 22a, 22b.

As may be seen in the illustrated embodiments, the separating wall 20 may be positioned in a non-symmetrical manner such that one of the pump chambers 22a has a volume greater than the other pump chamber 22b, the relative volumes defining the ratio of liquids dispensed from the first and second cavities. The first and second cavities may be provided with volumes that correspond substantially to the pumping ratio, although it may also be possible to provide substantially equivalent volumes, however filled with different amounts of liquids.

The supple portion 20a of the separating wall 20 provides an elastic biasing force that helps to push the elastic pump membrane 18 back to its unactuated position where the pump chambers 22a, 22b have their full volume.

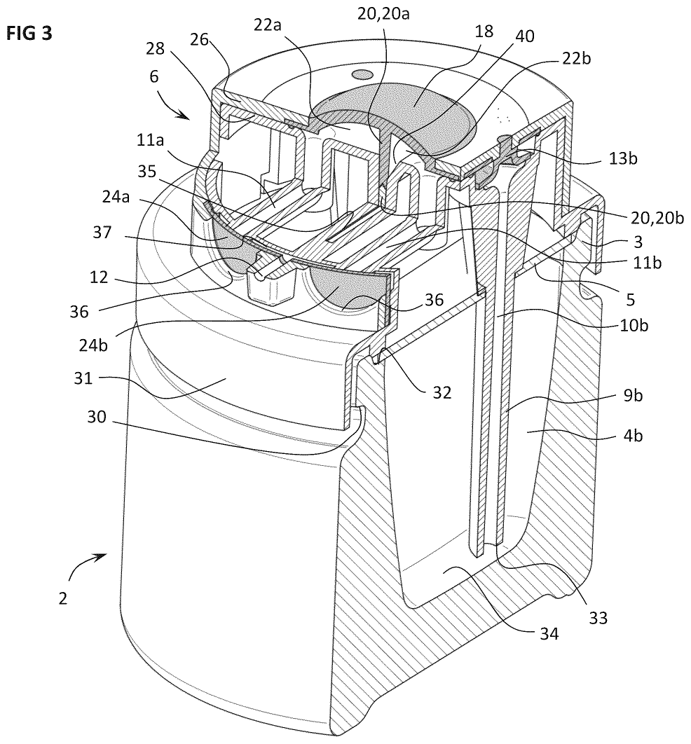

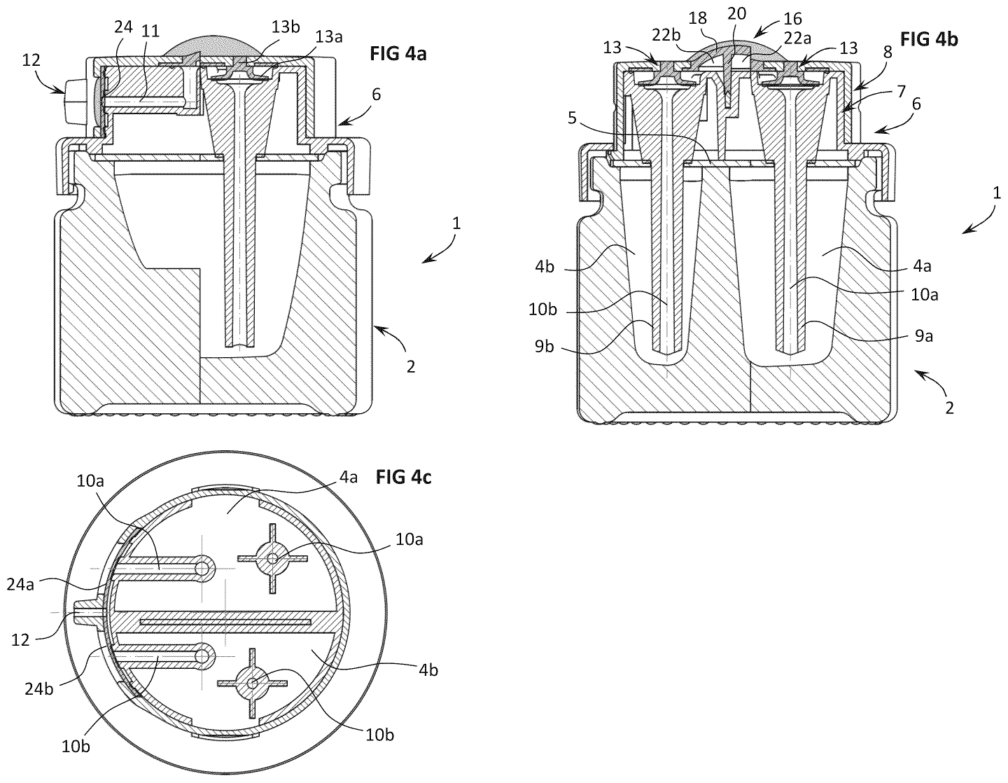

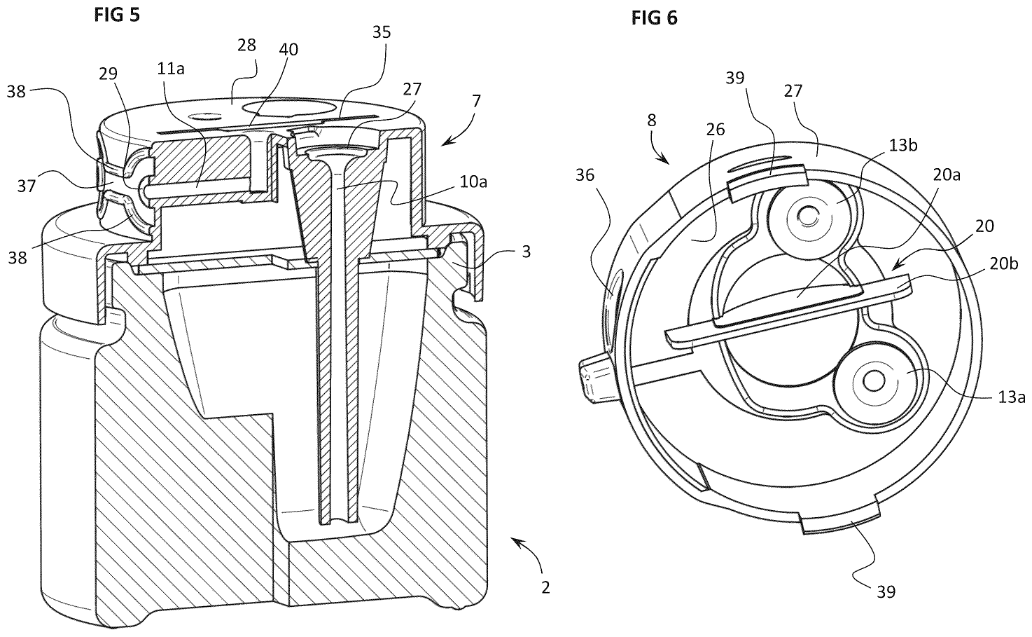

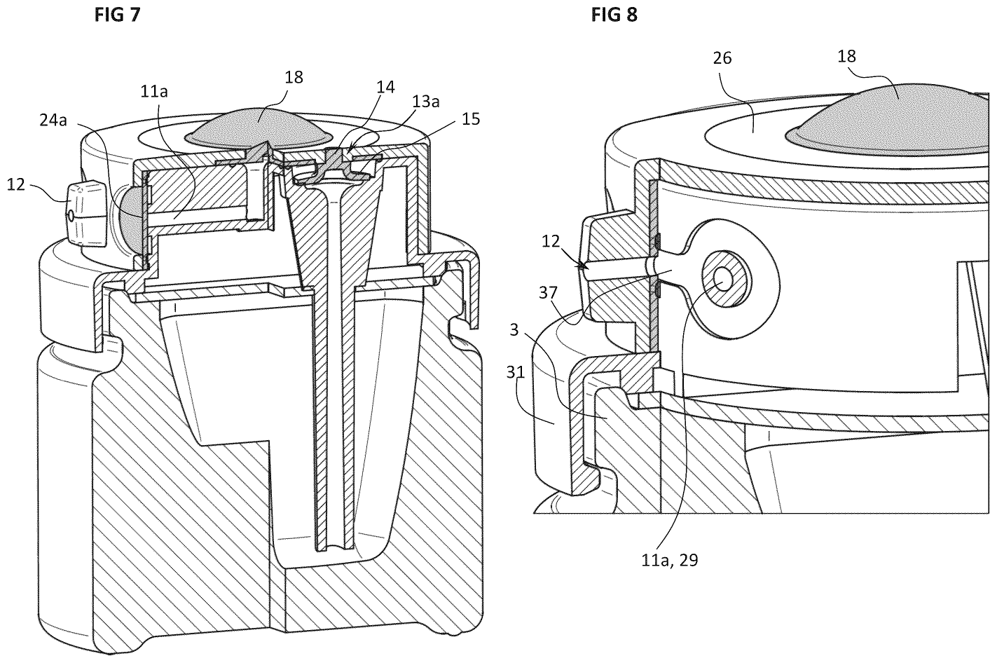

As best seen in FIGS. 3 and 5, there may be provided an indent 40 on the top surface 28 of the base part adjacent the slot 35, for instance by providing a chamfered empty portion on the slot, that allows some of the separating wall flexible portion 20a to collapse into when the pump membrane 18 is pressed down into the fully actuated position.

Although the feed tubes are shown as substantially rigid tubes that extend into a cavity of a substantially constant volume in a rigid container, it is possible within the scope of the invention to provide thin flexible container bags within which the liquid to be dispensed is encapsulated that collapses as liquid is extracted therefrom. Such solutions may for instance be used where it is desirable to avoid oxidation or contamination by air that would enter the container cavities as the fluids are being dispensed. In such configurations, a feed tube may be omitted or be made considerably shorter.

In embodiments as illustrated with a rigid container and fixed volume cavities, air may be allowed to enter the container cavity by a valve or by gas leakage in the interface between the dispensing pump device 6 and the container 2 that may be generally sealingly fitted together, however with some capacity to allow air into the container.

The first and second pump chambers 22a, 22b are further connected to respective outlet channels 11a, 11b that interconnect the pump chambers to an outlet nozzle 12 via outlet valves 24a, 24b. The outlet nozzle 12 has a single outlet orifice where the fluids coming from the two outlet channels 11b, 11a are mixed and simultaneously dispensed out off the single nozzle orifice.

The outlet valves 24a, 24b may be provided in the form of a flexible elastic membrane or flap that cover respective outlet orifices 29 of the outlet channels 11a, 11 b and that elastically bend away from the outlet channel orifices 29 by fluid pressure during fluid expulsion action of the pump mechanism 16. The outlet orifices 29 may be surrounded by a protuberance against which the elastic flap presses in the valve closed position. Holes 36 or spaces opposite the outlet orifices 29 may be provided in the cap part to allow elastic displacement of the valve membrane away from the outlet orifices.

An after-valve channel 37 is provided to guide the expulsed fluids to the outlet nozzle 12. The after-valve channel 37 may be provided as an indent on an outer surface of the base part or by providing a protuberance 38 surrounding the outlet orifices and the outlet nozzle orifice that sealingly presses against the elastic membrane of the outlet valves 24a, 24b.

The outlet valve elastic member may advantageously be made of an elastic polymer similar or identical to the material of the pump membrane and configured to be injection-molded with the rigid polymer portions of the cap part in a multi-component injection-molding process. In variants, the outlet valves may however be made of a material different to the material of the pump membrane.

While it is preferable to have the same materials for the pump membrane and for the flexible components of the inlet or outlet valves, within the scope of the invention it would also be possible to have different materials used for the valves and for the pump membrane, for instance using a tri-component molding process. Nevertheless, it is preferable to reduce the number of materials used and have a dual component molding process to reduce costs.

It is also possible within the scope of the invention to produce the seals separately from the cap part and to assemble them to the cap part by bonding, welding or simply by mechanical fixing, for instance having a stud with a certain elasticity that presses into a corresponding cavity. Such a configuration would still be benefit from the advantages conferred by the dual component injection molding of the pump membrane and separating wall with the cap part top wall 26.

The cap part 8 may have a top wall and a substantially cylindrical peripheral wall 27 extending therefrom forming a general cap shape that allows assembling on the base part 7 by axial insertion of the cap part over the base part. Latches 39 or other fixing mechanisms, or welding or bonding, may be provided to lock the cap part to the base part.

The dispensing pump device 6 as a whole may also have a general cap shape, for instance by having a substantially cylindrical peripheral wall 31 extending from the base part that fits over the rim 3 of the container 2. Within the scope of the invention, it may be noted however that the rim does not need to have a cylindrical circular shape and may have for instance an oval or square or polygonal or irregular shape and the base part would then have a corresponding shape to fit over the container.

### LIST OF FEATURES

Fluid dispenser 1
   Container 2
      Rim 3
         Outer flange
         Bottom shoulder 30
         Gasket seat indent 32
      First container cavity 4a
      Second container cavity 4b
         Bottom surface 34
   Gasket 5
   Pump 6
      Base part 7
         Top surface 28
         Peripheral wall 31
         First feed tube 9a
         Inlet channel 10a
         End 33
         Second feed tube 9b
         Inlet channel 10b
         End 33
         Slot 35
         First Outlet channel 11a
         Second outlet channel 11b
         Channel outlet orifice 29
         Outlet 12
         Valve seat 27
      Cap part 8
         Inlet valves 13
         Sealing lip 15
         Anchor portion (stem) 14
         Pump mechanism 16
         Pump membrane 18
         Separating wall 20
         Supple portion 20a
         Rigid portion 20b
         First pump chamber 22a
         Second pump chamber 22b
         Outlet valves 24
         Anchor portion
         Sealing lip
         Top wall 26
         Peripheral wall 27
         Valve membrane displacement hole 36
         After-valve channel 37
         Sealing protuberance 38
         Fixing latches 39
   Cover 30

1. A push actuated double fluid dispenser, comprising a container having a first cavity and a second cavity separated from the cap first cavity, and a dispensing pump device in a general form of a cap assembled to the container over the first and second cavities, the dispensing pump device comprising a base part and a cap part including a pump mechanism comprising an elastic flexible pump membrane push movable from an uncompressed state to a compressed state, wherein the pump mechanism further comprises a separating wall extending from an underside of the pump membrane and inserted into a slot in the base part, the separating wall separating a first pump chamber from a second pump chamber, both first and second pump chambers provided in a volume below the pump membrane, the first pump chamber connected fluidically to a first inlet channel and a first outlet channel, the second pump chamber connected fluidically to a second inlet channel and second outlet channel, the inlet channels fluidically interconnecting the respective first and second cavities to the respective first and second pump chambers, valves being positioned between the inlet channels and the pump chambers configured to allow fluid flow only in the direction from the cavities to the respective pump chambers, and the outlet channels interconnecting the pump chambers to an outlet nozzle of the dispenser, outlet valves being positioned in the outlet channels configured to allow fluid flow only in the direction from the pump chambers to the outlet nozzle.

2. The fluid dispenser of claim 1, wherein the cap part comprises a rigid top wall and the pump membrane protrudes above the rigid top wall.

3. The fluid dispenser of claim 1, wherein the pump membrane and at least a top wall of the cap part are integrally formed as an injection-molded multi-material part, the cap housing top wall being formed of a rigid thermoplastic polymer and the sealing membrane of a thermoplastic elastic polymer.

4. The fluid dispenser of claim 1, wherein the separating wall comprises a supple portion integrally formed with the pump membrane of the same material as the pump membrane, and a rigid portion formed of a different polymer more rigid than the polymer of the sealing membrane.

5. The fluid dispenser of claim 4, wherein the rigid portion is integrally formed with a top wall of the cap part in the same material as the top wall of the cap part.

6. The fluid dispenser of claim 1, wherein the inlet valve is made of the same material as the pump membrane.

7. The fluid dispenser of claim 1, wherein the outlet valves are made of the same material as the pump membrane.

8. The fluid dispenser of claim 1, wherein the inlet valve is made of an injection-molded component that is formed integrally with the cap part as a multi-material injection-molded part.

9. The fluid dispenser of claim 1, wherein the outlet valve is made of an injection-molded component that is formed integrally with the cap part as a multi-material injection-molded part.

10. The fluid dispenser of claim 1, wherein the inlet valve comprises a flexible sealing lip integrally formed with an anchor portion fixed to a top wall of the cap part, the flexible sealing lip pressing against a valve seat provided at an upper end of the inlet channels formed on the base part.

11. The fluid dispenser of claim 1, wherein the separating wall comprises a supple portion that is configured to collapse elastically when the pump membrane is pressed from an unactuated position to an actuated position in which the pump chambers are emptied.

12. The fluid dispenser of claim 1, wherein the outlet valves comprise a flexible membrane that press against an outlet end of the outlet channels and that are configured to be elastically biased when liquid is expulsed from the pump chambers.

13. The fluid dispenser of claim 12, wherein the cap part comprises holes or spaces opposite the outlet orifices configured to allow elastic displacement of the valve flexible membrane away from the outlet orifices.

14. The fluid dispenser of claim 12, wherein an outer surface of the base part comprises an after-valve channel formed as an indent or a protuberance surrounding the outlet orifices to guide expulsed fluids downstream of the outlet valves to an outlet nozzle of the fluid dispenser.

15. The fluid dispenser of claim 13, wherein an outer surface of the base part comprises an after-valve channel formed as an indent or a protuberance surrounding the outlet orifices to guide expulsed fluids downstream of the outlet valves to an outlet nozzle of the fluid dispenser.
